(19) United States
(12) Patent Application Publication
(10) Pub. No.: US 2010/0176167 A1
(43) Pub. Date: Jul. 15, 2010

(54) Firearm holster mount for vehicles

(75) Inventor: James Daniel Hudspeth, Arlington, TX (US)

Correspondence Address: James Daniel Hudspeth, 1301 Land Rush Drive, Arlington, TX, 76012, US

(73) Assignee: James Daniel Hudspeth, Arlington, TX (US)

(21) Appl. No.: 12/687,120

(22) Filed: Jan. 13, 2010

Related U.S. Application Data
(60) Provisional application No. 61/144,732, filed on Jan. 14, 2009.

(51) Int. Cl. B60R 7/04

(52) U.S. Cl. 224/275; 224/572

(57) ABSTRACT

A Firearm Holster Mounting System for Vehicles 5 is presented that includes a central hub mounting component 10 which acts as both a hub for the plurality of mounting straps 40 and a holster mounting point using the holster mounting straps 60. The side mounting straps 40, intended to support the mount and the holster with a firearm inside by connecting to the underside of a vehicle seat on each side toward the front of the seat suspension, are retained by quick release buckles 35 and the buckles are attached to the Central Mount 10 by passing through a series of adjustment slots 20 available laterally on the sides of the Central Mount 10. The rearward strap is contained by an additional quick release buckle 35 and allows a strap to be secured to the rear of the vehicle seat. This process ensures securely mounted firearms that can be adjusted in numerous ways due to the sliding straps 40 for side and rear adjustment.

### CROSS-REFERENCED TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Brief Summary of the Invention

This invention relates in general to accessories for firearms and, more particularly, to an adjustable firearm holster mount with a center hub type mount that suffices as a center hub for a pistol holster to be attached, with adjustable length web straps and seat hooks which allow a belt type holster to be mounted in a secure way. The design is intended to allow a belt holster or others some other type of holster to be attached and oriented on the mount as to provide a right or left hand draw and suspend the holster via the mount directly under an automotive seat firmly for safe transportation of the firearm and also more importantly to allow for quick retrieval of the firearm in case of an eminent threat of danger.

2. Background of the Invention

In recent years, laws for carrying firearms, both on the person and inside vehicles have changed in many states to allow citizens to lawfully be in possession of loaded firearms. This being the case, there are few places suitable to place the weapon inside the vehicle that will assure that it will be readily available as well as fully protected from it's environment.

There are several types of holsters available on the market. They range in shapes and sizes, but have several different classifications. Typically you will find holsters that ride on a belt and used by law enforcement and military, as well as some hunting situations. Being exposed, these holsters are not for use with concealed carry permits available in most states in the U.S. A second type of holster is known as an ITW holster, or Inside The Waistband. These holsters are a favorite among concealed carry permit holders since they allow the firearm to be concealed easily. Both of these types of holster come in many shapes and sizes to fit different types of handguns and are good for carrying the firearm when walking around. Once you sit down into the car, the holster becomes uncomfortable and inaccessible with the seatbelt on. There are other types of holsters, but the ones mentioned above are typically most adaptable to some type of belt, be it a waist belt or a gun belt.

Most vehicles today have some space underneath the front driver seat. This area is sometimes used for stereo equipment or to store front visors for the windshield. Many citizens choose to keep a firearm inside their automobile for personal protection and obviously concealed carry permit holders choose to have a firearm on their person for protection. Once you get into the vehicle, the firearm must be stowed or tucked away at risk to damage or making the firearm inaccessible in a short period of time due to the many of storage.

There is no prior art to suggest ways to deal with the problems associated with storage of firearms inside a vehicle, even less when you have a requirement rapid tactical deployment of the firearm.

Thus, it is an object of the invention to provide a means to secure a firearm holster to the inside of an automobile, preferably under the front seat of the vehicle.

It is another object of the invention to provide an adjustable mechanism to attach the holster to a wide variety of automotive seats and allow for left or right as well as front to back adjustability.

It is another object of the invention to provide a means to quickly retrieve the firearm from the holster and replace the firearm into the holster as to have a safe and secure method for retaining the firearm in a ready position.

It is another object of the invention to provide to be able to adjust the position of holster to place the firearm in a convenient position.

It is another object of the invention to provide a way to secure virtually any type of belt loop holster or ITW holster to the central mounting hub and provide a platform to mount any type of handgun.

It is another object of the invention to provide an easy way to install the device into automobiles by means of adjustable straps and easy to install hooks or looping straps that can attach in many different ways.

It is another object of the invention to provide an out of site holster location for the firearm to keep the firearm concealed in the vehicle, while still being readily available.

It is another object of the invention to include this system into an actual holster by providing the same strapping system to each size of holster that is unique to each size gun. This is the complete auto seat attachment solution.

### BRIEF SUMMARY OF THE INVENTION

The firearm holster mounting system for vehicles can be installed on virtually any type of front car seat that has adequate room for the holster. It is attached to the underside of the seat with at least three strap attachment points to provide a solid mounting point. The preferred embodiment comprises a rigid center mounting section for securing the firearm holster to the device with a belting type mechanism that is adjustable front to back. The attachment points for the center section should be easy to the center mounting section for additional adjustment. The adjustable attachment straps should include some for of quick release to allow the straps to be easily installed and the attached to the center mounting section and adjusted for proper fit. The rear attachment strap can be permanently attached, but should include a quick release mechanism for the actual adjustable strap. On the terminating end of the adjustable strap, a particular hook should be installed to facilitate installation of the strap on to the underside of the seat. This hook should be of sufficient material to hold the weight of a firearm and be easily attached to a variety of points under the front seat of an automobile. In addition to a hook, a magnetic attachment point could be provided to attaché to the metal plate type front seats on newer vehicles.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates the complete system with the straps attached and without a holster attached for a particular firearm.

FIG. 2 illustrates a rear side of the invention with any additional features identified.

### DETAILED DESCRIPTION OF THE INVENTION

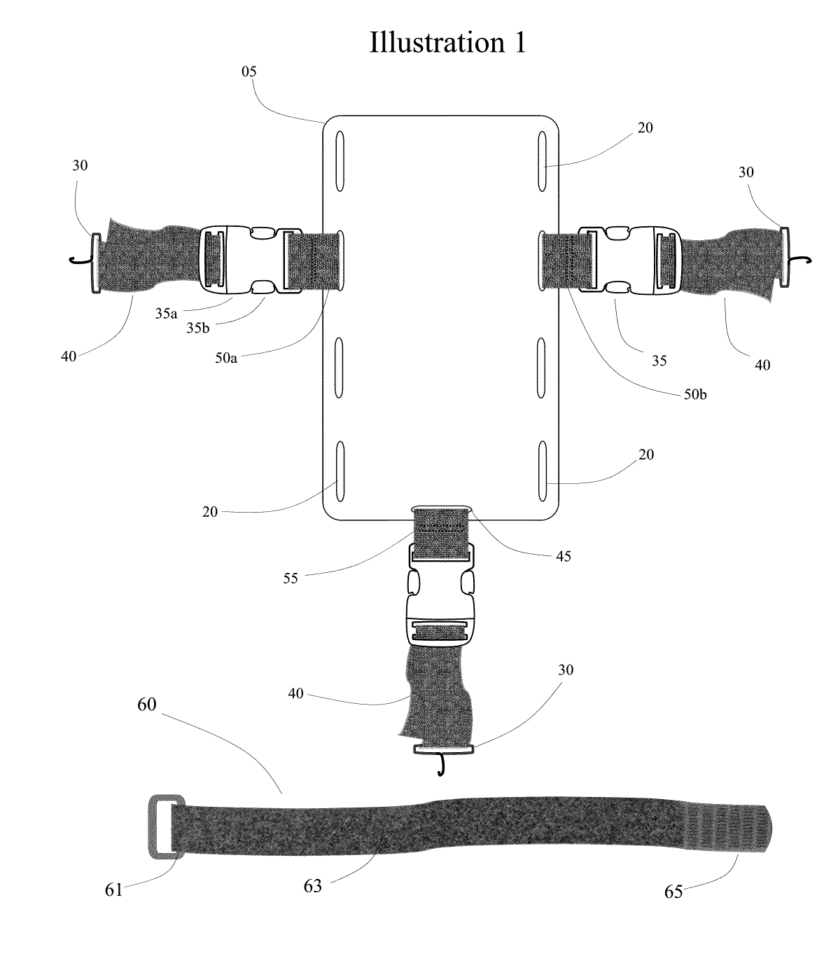

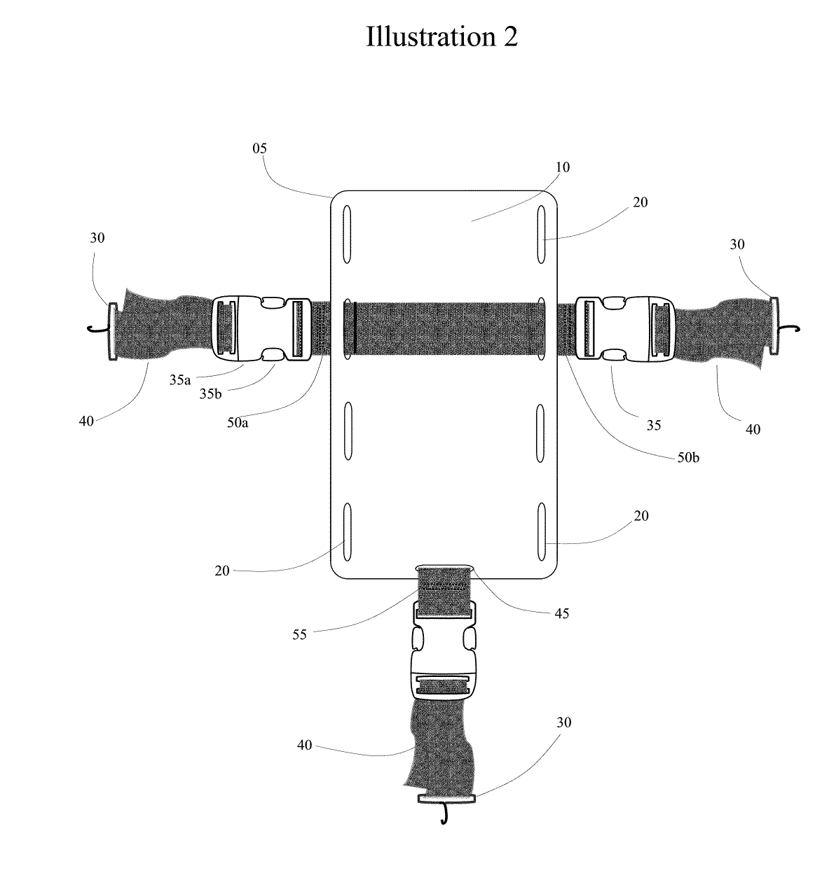

The present invention is best understood in relation to FIGS. 1 and 2 of the drawings, like numerals being used for like elements of the various drawings.

FIG. 1 illustrates a frontal view of the present invention with the main section or Mount 05 being the hub of the invention. This component can be made of any type of material sufficient in strength such as leather. Various slots 20 are fashioned around the edge of the main section 05. These slots 20 locations are situated along the sides and bottom of the main section 05 as well as on the bottom, where a quick release buckle 35b is attached permanently with a loop of nylon webbing 55 to facilitate a rear attachment point. There are a plurality of hooks 30 which are designed to attach to many different points on the bottom of a car seat from the frame to the suspension of the seat. Other methods of connection could be suggested by those skilled in the arts. Each hook is attached to a strap webbing 40 type of material and looped through a male quick release buckle 35a. The two side quick release buckles 35 are attached to each other via a length of Velcro, both the hook 50a and the loop 50b, which are connected individually to quick release buckles 35a. As previously mentioned, the slots 20 are available for various universal fit capabilities. Since the Velcro can be released, it can be positioned up and down through the slots 20 to allow the firearm holster to be place forward and backward to be positioned for maximum concealment under the seat. Various locations of slots 20 along the side of the mount 5 are available to allow for forward and rear mounting of the holster for proper positioning. A standard Velcro binding strap 60 attaches a belt holster of choice to the Mount 5 utilizes the remaining slots to securely attach the holster, which fits the pistol to be mounted, securely to the Mount 5. The Holster Mounting Strap 60 is comprised of a length of Velcro loop 63 attached to a smaller patch of Velcro Hook 65 and on the opposite end of the Velcro Hook 65 is attached a plastic D Ring that is allows the strap to be tightened and set using the two pieces of Velcro. In the current version of the present invention, there are approximately four side slots 20 which requires three of the Holster Straps 60 to fill the remaining slots once the side buckles 50 are attached in the appropriate location for forward and backwards adjustment. The top strap 60 should be placed through the belt loop on the holster to aid in further holster retention and security.

Side to side adjustment comes from the length of nylon webbing 40 and the quick release buckle 35a, which is also an adjustable slide configuration. These two components work together on both sides to give and take up the slack. Also the quick release buckles 35 allow for the present invention to be removed. Once installed to the underside of a front car seat with the side hooks and the tail hook tightened, it would be difficult to remove the present invention without the release from the buttons on the buckles 35.

FIG. 2 illustrates the many of the same features as FIG. 1 details. The figure depicts the backside of the present invention and details the path for the side strap buckles. As you can see, the Velcro on the straps 50a and 50b can be disconnected and moved up or down the Mount 5. Ultimately, when the Firearm Holster Mounting System is installed into the vehicle, this is the side that faces down and is at the bottom, slinging the holster under the front seat.

I claim:

1. A firearm holster mounting system for vehicles, the vehicle having a front seat with sufficient space between the floor of the vehicle and the frame of the seat to allow a pistol within a holster to be placed in the space in a multitude of positions and secured to the bottom or side of the seat by means the mounting system comprised of a plurality of straps connected to either a central mounting platform or directly to a holster of correct size to contain a pistol, such that there are straps protruding from the sides and rear, terminating in a strapping hook of the proper size to fit into the many holes, corners, suspension and frame components present under the front seat, or a loop, between which has quick adjustment buckles for securing package, as well as a strapping mechanism to adhere a belt type holster to the central mounting platform, if holster is not attached to the straps.

2. The firearm holster mounting system according to claim 1 wherein the holster or holster central mounting platform to which straps can be moved forward or rearward, or not at all.

3. The firearm holster mounting system according to claim 1 wherein the straps contain a mechanism such as quick adjustment pulls to tighten the mount securely.

4. The firearm holster mounting system according to claim 1 wherein the straps contain a method for remove to release the system from the installed position, such as quick release buckles.

5. The firearm holster mounting system according to claim 1 wherein the straps terminate in some means to secure the straps to the frame of the vehicles front seat.

6. The firearm holster mounting system according to claim 1 wherein there is a plurality of straps to provide tension in various directions simultaneously to suspend the firearm holster mount as well as the firearm inside the holster.

7. The firearm holster mounting system wherein the straps originate from a central platform, either a holster, or a mount for a holster, and the straps can be manipulated for mounting in various positions.

8. The firearm holster mounting system according to claim 7 and further comprising a plurality adjustment slots longitudinally oriented such as to offer various options for adjustment.

9. The firearm holster mounting system wherein the plurality of adjustment slots on the central mounting platform are used first for adjustment and second for retaining the firearm holster to the central mounting platform.

10. The firearm holster mounting system according to claim 9 wherein the a separate or attached strap is used to securely attach the particular firearm holster that fits the firearm being installed under the front seat.

11. A firearm holster mounting system for a firearm, the firearm being of adequate size to fit into the prescribed location, and having a holster that fits this particular firearm should be attached to the central mounting platform with sufficient straps to secure the holster to the central mounting platform.

12. The firearm holster mounting system according to claim 5 wherein the means of connecting to the vehicles seat comprises a curving selection of material to provide a hooking means to attach the strap end to the frame of the vehicle seat.

13. An improved method of securing a firearm to a reachable position inside of a vehicle, preferably under the front side of the front seat from within a contained holster that cannot be pulled out but is instead fixed to the underside of the seat of the vehicle by use of a strapping method that affixes a plurality of straps that can be tightened easily so as to suspend the holster package in such a presentation that allows the occupant sitting in the seat to have ready access to the firearm from inside the protection of the holster attached to the mounting platform.
